(19) United States
(12) Patent Application Publication
(10) Pub. No.: US 2009/0281942 A1
(43) Pub. Date: Nov. 12, 2009

(54) SYSTEMS AND METHODS FOR DONATING

(76) Inventors: JOSEPH R. RANDAZZA, Boca Raton, FL (US); Alan Yuster, Boca Raton, FL (US)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/420,753

(22) Filed: Apr. 8, 2009

Related U.S. Application Data
(60) Provisional application No. 61/044,389, filed on Apr. 11, 2008.

(51) Int. Cl. G06Q 40/00; G06Q 30/00

(52) U.S. Cl. 705/39; 705/14.4

(57) ABSTRACT

Disclosed are systems and method for donating.

This application claims the benefit of U.S. Application Ser. No. 61/044,389 of JOSEPH R. RANDAZZA AND ALAN YUSTER filed Apr. 11, 2008 for SYSTEMS AND METHODS FOR DONATING, the contents of which are herein incorporated by reference.

### BACKGROUND OF THE INVENTION

### Field of the Invention

This invention relates generally to systems and methods for donating and, more particularly, to systems and methods that encourage donations and ease fund raising efforts for charities.

### SUMMARY OF THE INVENTION

According to an aspect of the present invention, there is a method for a system having a plurality of first entities, and a second entity, each first entity having a respective bank account, each first entity being non-affiliated with each of the other first entities, the second entity being non-affiliated with each of the first entities. The method comprises the steps, performed under control of the second entity, of receiving a mass of metal from a person, the person being a member of the general public, the mass of metal not being U.S. currency; and crediting the bank account of a selected one of the plurality of first entities with an amount, the amount corresponding to a market value of the mass of metal.

### BRIEF DESCRIPTION OF THE DRAWINGS

References are made to the following text taken in connection with the accompanying drawings, in which:

FIG. 1 is a diagram of a first exemplary system for communication and contribution to various charities.

FIG. 2 is television screen in the first exemplary system, identifying a charity and giving directions on how to proceed with a donation.

FIG. 3 is a diagram of a mailing envelope in the first exemplary system.

FIG. 4 is a diagram showing a possible sequence of interactions in the first exemplary system.

FIGS. 5A and 5B constitute a diagram emphasizing some possible implementations of the interactions shown in FIG. 4.

FIG. 6 is a diagram showing a possible relationship between record data in the first exemplary system.

FIG. 7 is a diagram of a second exemplary system for communication and contribution to various charities.

FIG. 8 is a diagram of a mailing envelope in the second exemplary system.

FIG. 9 is a diagram showing a possible sequence of interactions in the second exemplary system.

FIGS. 10A and 10B constitute a diagram emphasizing some possible implementations of the interactions shown in FIG. 9.

FIG. 11 is a diagram showing a possible relationship between record data in the second exemplary system.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

### First Exemplary Embodiment

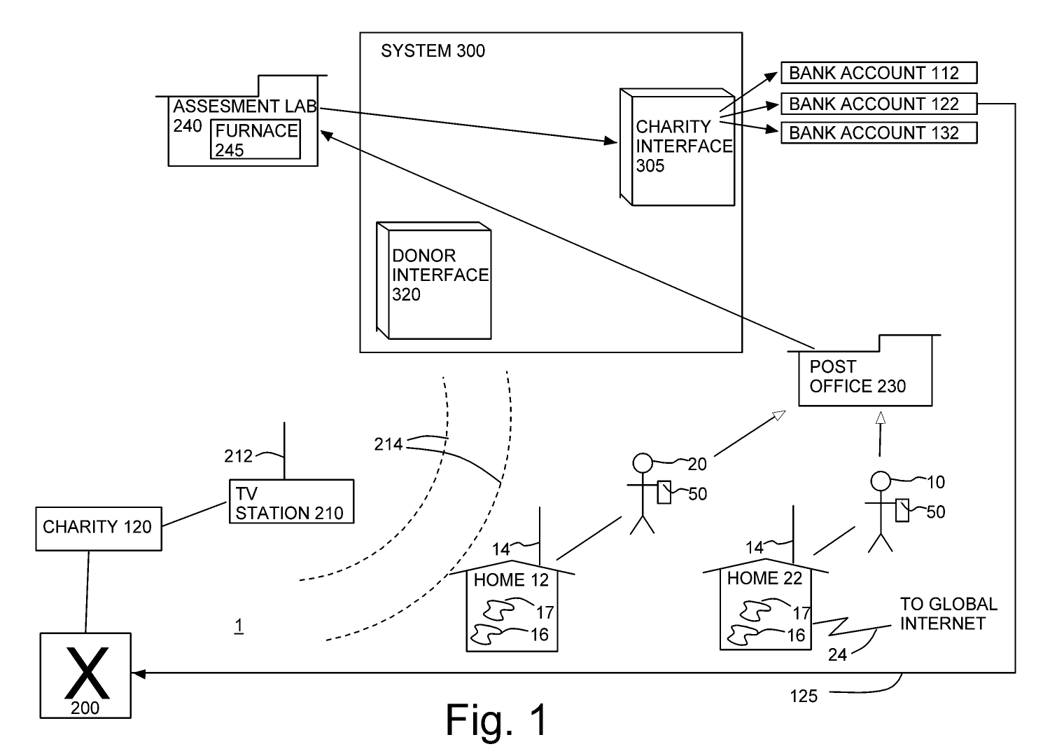

FIG. 1 shows exemplary system 1, including system 300 in accordance with an exemplary embodiment of the present invention. System 300 includes a set of people, hardware, data, and computer program instructions to carry out certain functions described below.

Location 200 has been impacted by a hurricane. Location 200 is on the Gulf Coast of the United States.

Charitable organization 120 learns of this problem affecting location 200 and purchases an advertisement, according to which television station 210 is to broadcast television signal 214 via antenna 212. Person 20 residing in home 12 receives the message from charity 120, via reception antenna 14.

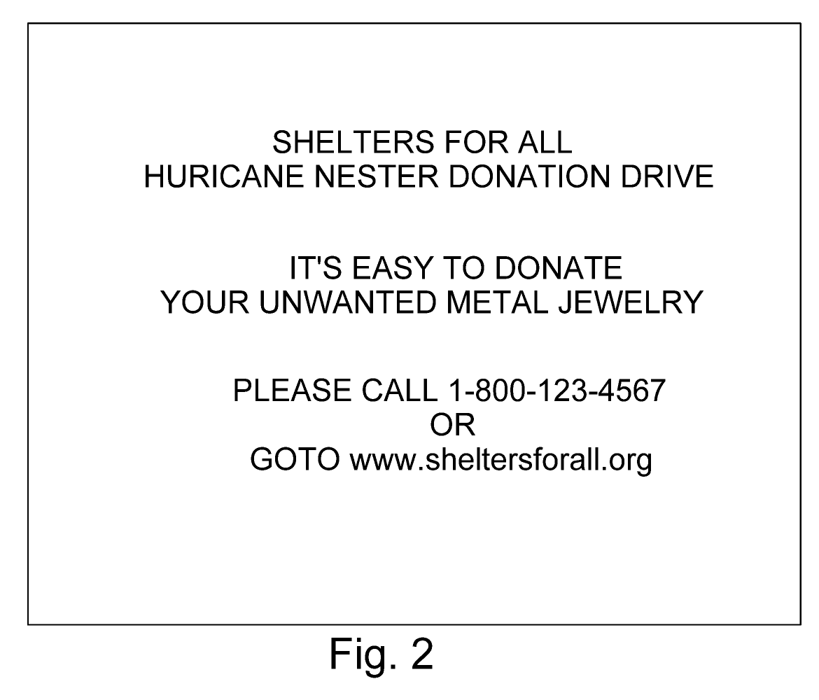

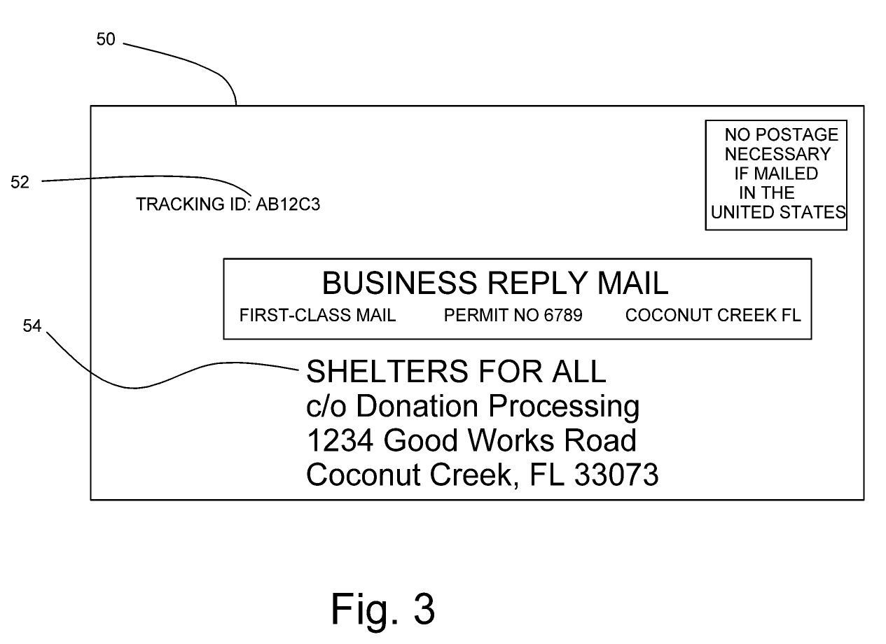

FIG. 2 shows a television screen, in home 12, displaying the message sent by charity 120 via television signal 214. Person 20 calls the number given in the message, and, responsive to the call from person 20, system 300 selects charity 120; and electronic processor(s) in system 300 generates an association of person 20 to charity 120, and generates an association of tracking identifier 52 (FIG. 3) to person 20.

In the act of selecting described above, system 300 selects the charity depending on telephone signals. For example, system 300 may be configured to receive telephone calls on multiple telephone numbers, with a particular number dedicated to charity 120. Thus, when a call comes in on the number dedicated to charity 120, system 300 thereby selects charity 120. Alternately, personnel in system 300 may select, or confirm selection, based on what person 20 says in the telephone discussion.

System 300 then sends envelope 50 to the home of person 20.

FIG. 3 shows the envelope sent by donor interface 320. Envelope 50 includes an envelope bearing tracking identifier 52, and a name 54 corresponding to charity 120.

Person 20 takes his bracelet 16 from his home 12 and places bracelet 16 in mailing envelope 50. Person 20 brings envelope 50 to post office 230, which sends envelope 50, containing bracelet 16.

In response to receiving envelope 50, assessment lab 240 assesses a market value of the metal in bracelet 16. System 300 may then inform person 20 of the assessed market value, and give person 20 the option of canceling the donation.

In response to identifier 52 on envelope 50, system 300 selects bank account 122, belonging to charity 120, and sends funds to bank account 122, the amount of the sent funds corresponding to the assessed market value.

Charity 120 uses a portion of these sent funds to transfer goods and services 125 to location 200, to address damage caused by the hurricane.

System 300 and charity 120 are non-affiliated, meaning that they are not affiliates with respect to each other. Is this patent application, concerns are affiliates of each other when one concern controls or has the power to control the other, or a third party or parties controls or has the power to control both. Power to control is described in Section 121 of the U.S. regulations of the Small Business Administration.

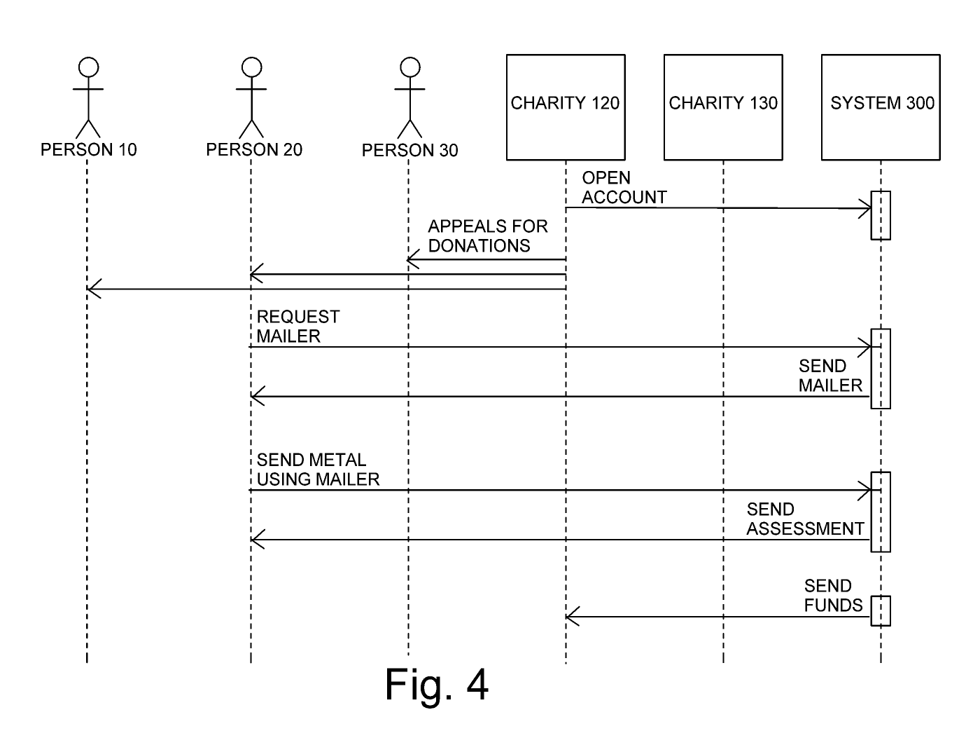

FIG. 4 is a diagram showing sequences of messages and materials exchanged between people, data, and electronic processors in system 1. Each of the rectangles under the box labeled system 300 is a process invoked in response to a message received by system 300. The process could be facilitated, enabled, or carried out, by a computer executing computer instructions to effect a function of the process.

Charity 120 registers, or opens an account, with system 300. This act of opening an account may be performed by charity 120 by filling out a form provided by system 300 online, mailing a paper form to system 300, or with a mere phone call in which a person in system 300 collects relevant information. An account record now created in system 300 for charity 120 includes payment information, allowing system 300 to send donor funds to charity 120. This payment information could be an ACH routing number, or could be a mere mailing address for checks to be sent to charity 120.

As shown in FIG. 4, charity 120 may send messages to a plurality of people, including person 10, person 20, in person 30. These messages may be in the form of a television advertisement (FIG. 2), and advertisement on a website, or an advertisement in a hard copy publication.

Person 20 responds to the message from charity 120, by calling system 300 to request an envelope. System 300 sends the envelope to person 20, who then responds by placing metal in the envelope and sending the envelope to system 300. Lab 240 assesses the value of the metal, and system 300 sends an assessment to person 20. System 300 may then send funds to charity 120.

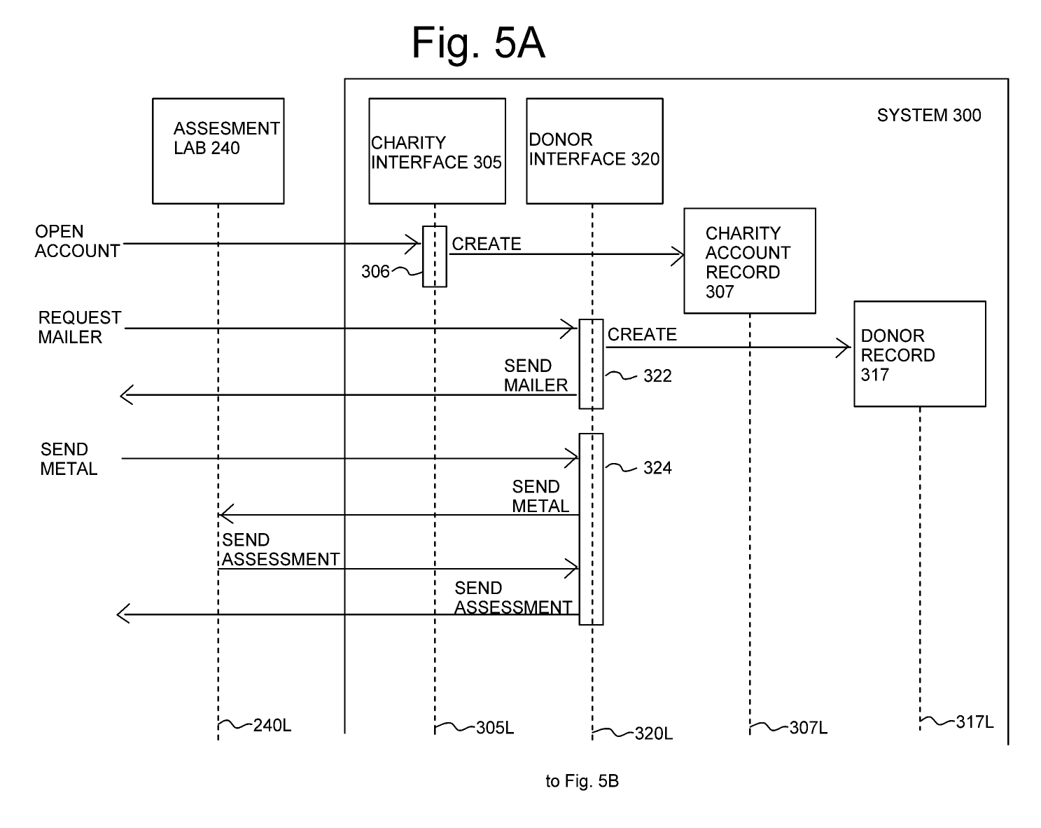

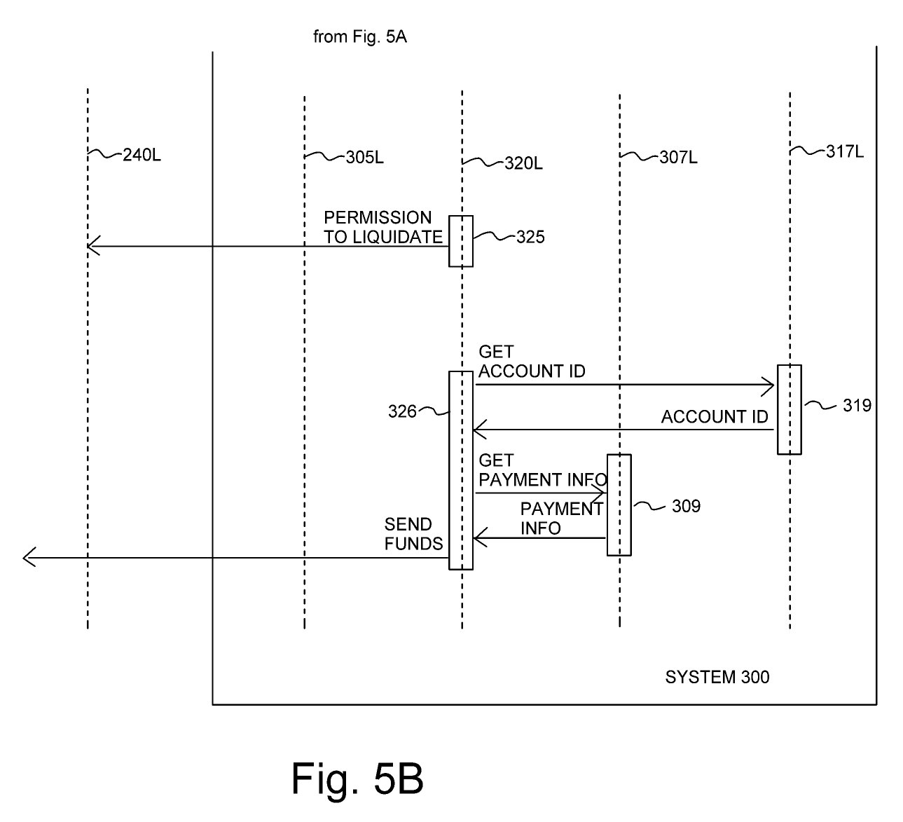

FIGS. 5A and 5B show a possible implementation of the functionality described in connection with FIG. 4. Charity interface 305 includes a set computer program instructions to facilitate, enable, or carry out certain functions that act to communicate with charities. Each of the rectangles under the box labeled 305 is a process facilitated, enabled, or carried out by execution of some of these computer program instructions in interface 305.

Donor interface 320 includes a set computer program instructions to facilitate, enable, or carry out certain functions that act to communicate with donors. Each of the rectangles under the box labeled 320 is a process facilitated, enabled, or carried out by execution of some of these computer program instructions in interface 320.

When charity 120 opens an account, process 306 creates an account record 307, containing payment information for charity 120.

When person 20 requests an envelope, process 322 creates a donor record 317 for person 20. Donor record 317 contains the tracking ID number 52 on the envelope to be sent to person 20, and contains an identification of account record 307.

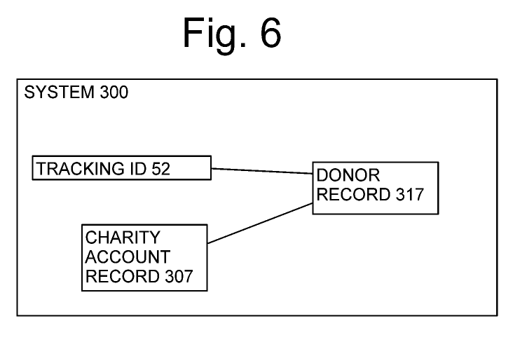

FIG. 6 shows a relation between donor record 317 and account record 307 in an electronic memory, before process 322 sends the envelope to person 20. In the structures shown FIG. 6, lines represent a reference, such as a pointer, between one element and another. These references are not necessarily direct memory address pointers. Instead, more generally, each reference is a data entity, stored in association with one (referencing) element, that enables a processor to find a related (referenced) element. To physically address the referenced element, the processor may subject the reference to various translations or mappings. In the case of record 317, the reference to record 307 may be simply the name of charity 120.

When system 300 receives the envelope back from person 20, system 300 sends the metal, contained in envelope 50, to assessment lab 240, as depicted by process 324. Assessment lab 240 determines a market value of the metal sent by system 300, and sends back a message to system 300 to inform system 300 of the assessed market value. In response, system 300 uses the tracking identifier 52 on envelope 50 to find donor record 317, to send donor 20 a message informing donor 20 of the assessed market value.

If donor 20 does not cancel the donation within 10 days, system 300 sends a message to assessment lab 240, giving assessment lab 240 permission to liquidate the metal (process 325).

If donor 20 does not cancel the donation within 10 days, process 326 uses the tracking identifier 52 on envelope 50 to find donor record 317, invokes process 319 to find charity account record 307, and invokes process 309 to find the payment information for bank account 122, belonging to charity 120, and sends funds to bank account 122, the amount of the sent funds corresponding to the assessed market value.

Although a one-to-one relation between donation and payment to charity has been illustrated, of course multiple donations may be accumulated and sent to the charity in a common payment. For example, system 300 may provides monthly audited reports and accumulated payments to charity 120.

Charity 120, named “Shelters for All”, is a United States 501(c)(3) nonprofit organization, meaning that person 20 may be eligible to claim a deduction for the value of the donated jewelry. System 300 sends person 20 a receipt for the assessed value.

Charity 110 owns bank account 112. System 300 and charity 110 are non-affiliated.

Charity 130 owns bank account 132. System 300 and charity 130 are non-affiliated.

In summary, in the first exemplary embodiment, system 1 is responsive to an event, such as a hurricane or earthquake. The system transmits an event-related-message to multiple people, by posting a message on a website or by traditional publicity paths, such as newspapers, TV, or radio. The message directs people to contact the system to request a shipping kit from the system and, after receiving the shipping kit, mail jewelry to the system. After receiving the jewelry, the system assesses the market value of the metal in the jewelry and sends a message, via postal mail or e-mail for example, to the person, to propose a donation amount based on the assessed market value. If the person does not cancel the transaction, the system then proceeds to transfer a corresponding amount of funds to a common account for relief of the event.

### Second Exemplary Embodiment

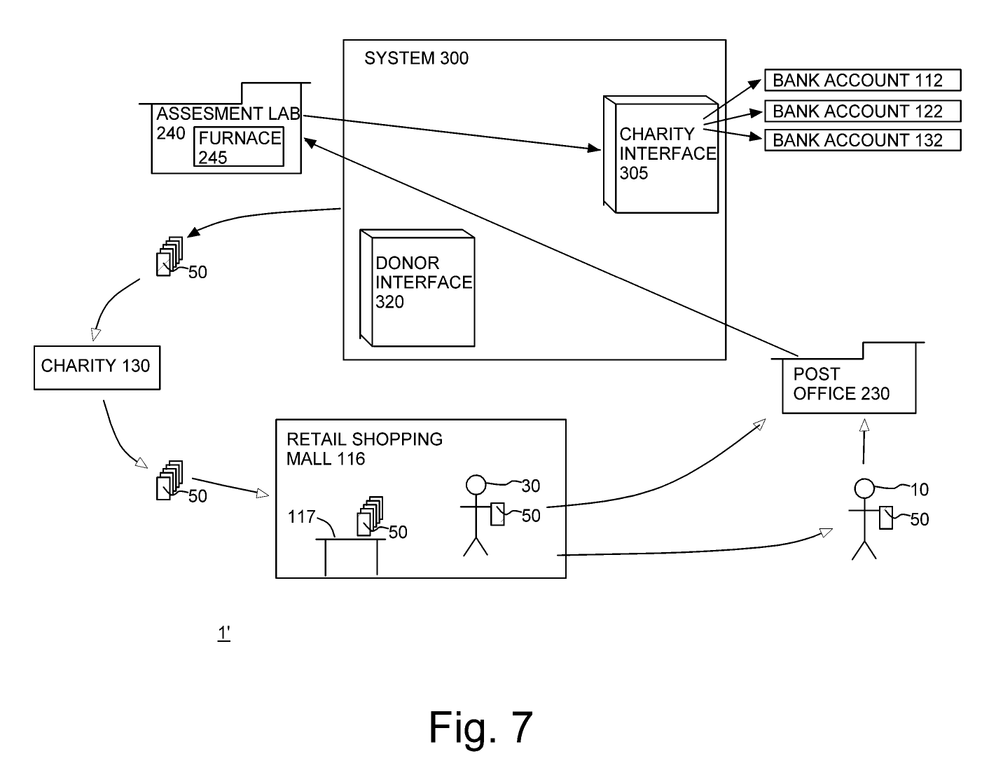

FIG. 7 shows exemplary system 1′, including system 300 in accordance with another exemplary embodiment of the present invention. System 300 includes a set of people, hardware, and computer programs to carry out certain functions described below.

Charity 130, named “Friendly Assistance”, is a United States 501(c)(3) nonprofit organization, meaning that persons donating to charity 130 may be eligible to claim a deduction for the value of the donation. Charity 130 has an ongoing mission of promoting community-based, grass-roots, donations in the county of Anywhere, Texas. Charity 130 spends these donations to provide food and shelter to children and families in need residing in the county of Anywhere, Texas.

System 300 is located in Coconut Creek Fla. Charity 130 requests that system 300 sends multiple envelops 50 to charity 130. In response to this request from charity 130, charity interface 305 of system 300 sends multiple envelopes 50 to charity 130.

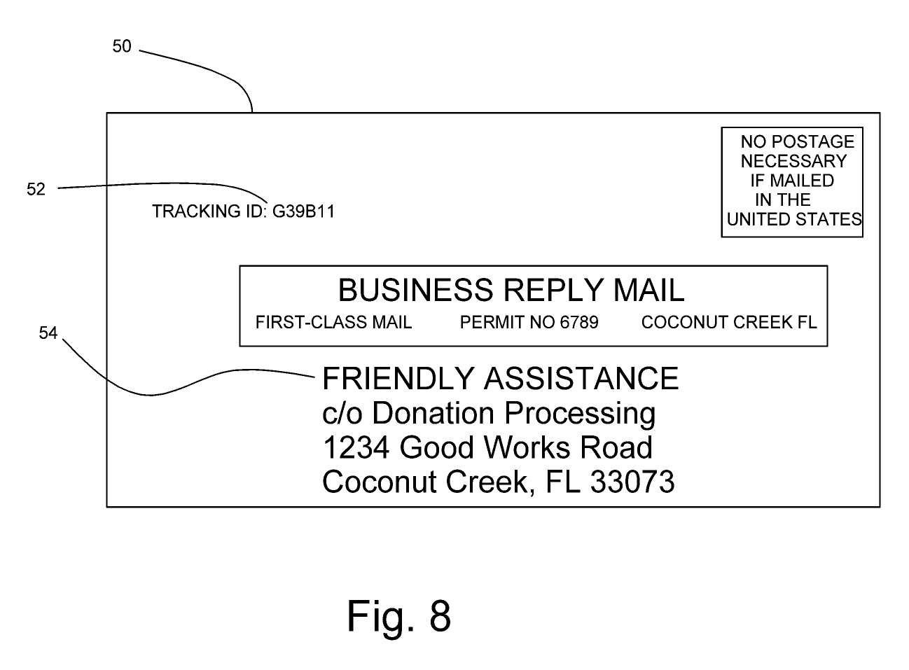

FIG. 8 shows one of the envelopes 50 sent by charity interface 305. Envelope 50 includes a tracking identifier 52, and a name 54 corresponding to charity 130.

Charity 130 then places the set of envelopes 50 on table 117 in retail shopping mall 116. Retail shopping mall 116 is located in the county of Anywhere, Texas.

Person 30 makes a visit to retail shopping mall 116 to make a retail purchase. During the visit, person 30 takes an envelope 50 from table 117. After leaving mall 116, person 30 takes a mass of silver, belonging to person 30, and places the mass of silver into envelope 50. Person 30 then brings envelope 50 to post office 230, which sends envelope 50, containing the mass of silver.

In response to receiving envelope 50 from person 30, assessment lab 240 assesses a market value of the mass of silver.

In response to identifier 52 on envelope 50 from person 30, system 300 selects bank account 132, belonging to charity 130, and sends funds to bank account 132, the amount of the sent funds corresponding to the assessed market value of the mass of silver.

Person 10 makes a visit to retail shopping mall 116 to make a retail purchase. During the visit, person 10 takes an envelope 50 from table 50. Subsequently, person 10 takes a mass of gold, belonging to person 10, and places the mass of gold into envelope 50. Person 10 then brings envelope 50 to post office 230, which sends envelope 50, containing the mass of gold.

In response to receiving envelope 50 from person 10, assessment lab 240 assesses a market value of the mass of gold.

In response to identifier 52 on envelope 50 from person 10, system 300 selects bank account 132, belonging to charity 130, and sends funds to bank account 132, the amount of the sent funds corresponding to the assessed market value of the mass of gold.

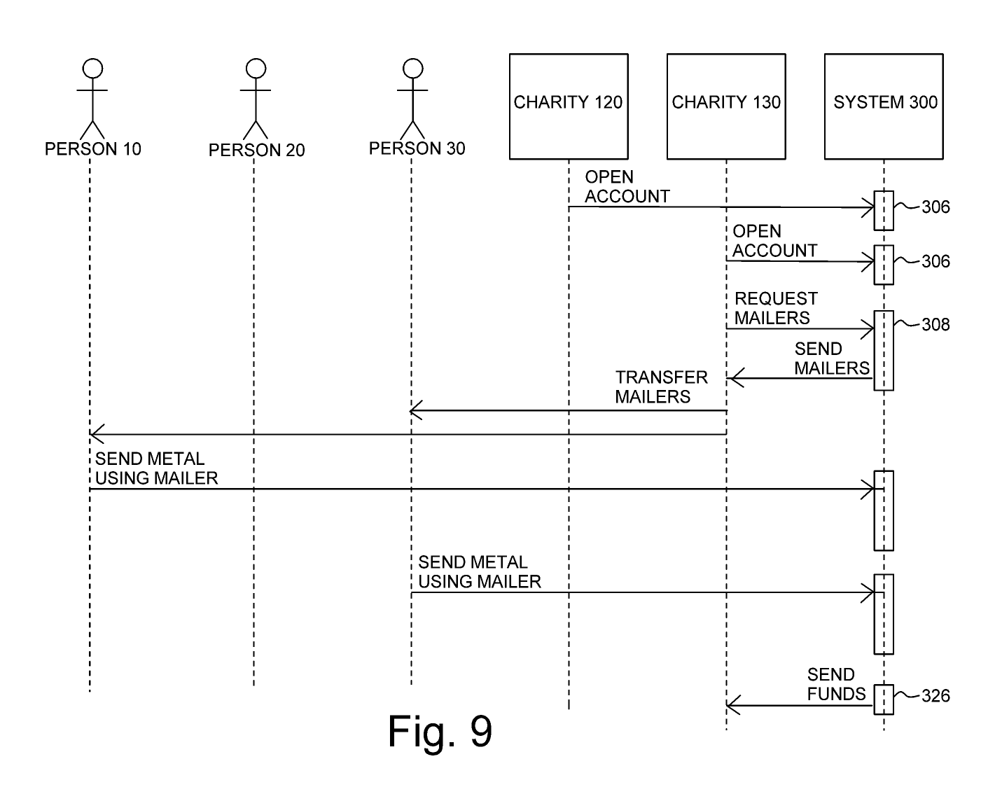

FIG. 9 is a diagram showing sequences of messages and materials exchanged between people, data, and electronic processors in the system 1. Each of the rectangles under the box labeled system 300 is a respective process invoked in response to a message received by system 300. The respective process could be enabled, or carried out, by a computer executing computer instructions to effect a function of the process.

Referring to FIG. 9, charity 130 registers, or opens an account, with system 300, invoking process 306. Charity 130 requests a set of envelopes 50 from system 300 and, responsive to this request, system 300 sends charity 130 a set of envelopes 50 (process 308).

Charity 130 transfers some of the received envelopes 50 to members of the general public, such as persons 10 and 30. Persons 10 and 30 then use their respective envelopes to send their respective personal property to system 300, via a courier service such as the U.S. Mail.

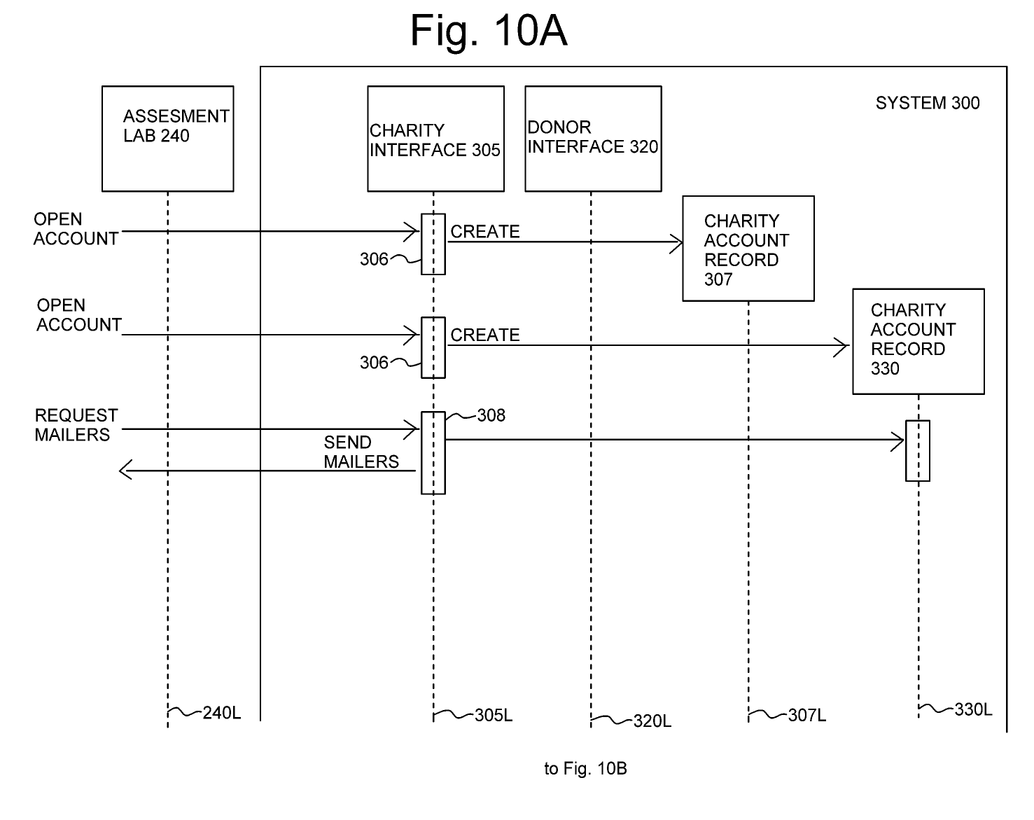

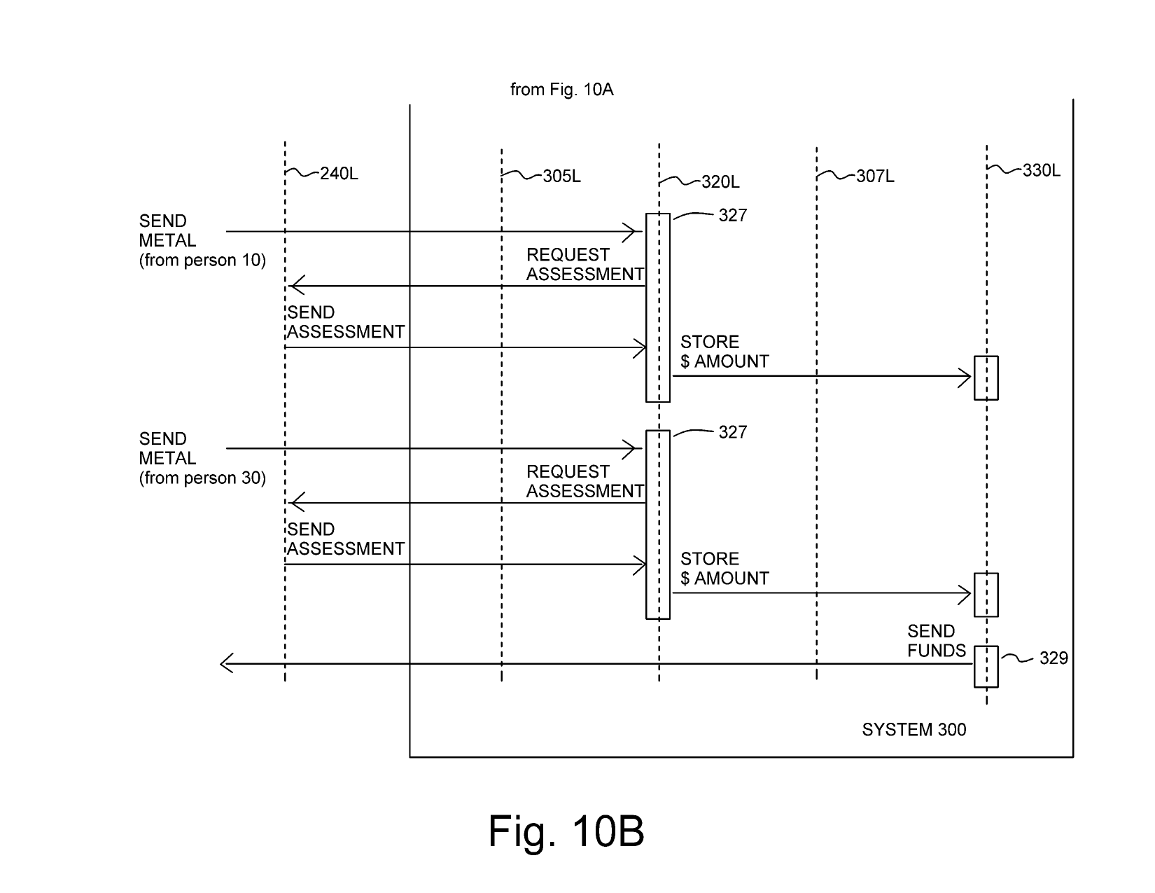

FIGS. 10A and 10B show a possible implementation of the functionality described in connection with FIG. 9. When charity 130 opens an account, process 306 creates an account record 330, containing payment information for charity 130.

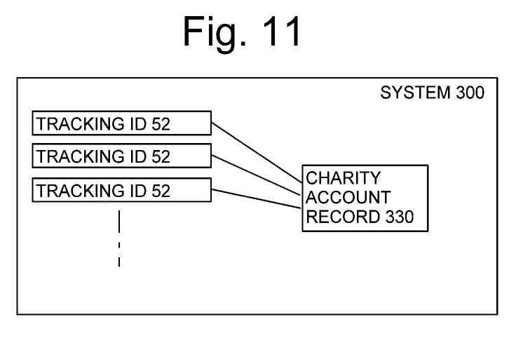

When charity 130 requests a set of envelopes 50, process 308 creates a data structure (FIG. 11), in an electronic memory, storing an association between charity account 330 and the respective tracking numbers 52 of each of the envelopes 50 in the set of envelopes. In the structures shown FIG. 11, lines represent a reference, such as a pointer or identification code, between one element and another.

When system 300 receives an envelope 50 from person 10, system 300 sends the gold, contained in the envelope 50, to assessment lab 240. Assessment lab 240 determines a market value of the gold sent by system 300, and sends back a message to system 300 to inform system 300 of the assessed market value. In response, system 300 uses the tracking identifier 52, and the data structure shown in FIG. 11, to access charity account record 330. (This is one type of example of selecting a charity responsive to a signal from a courier parcel). System 300 stores the assessed dollar amount into charity record 330. (process 327).

When system 300 receives an envelope 50 from person 30, system 300 sends the silver, contained in the envelope 50, to assessment lab 240. Assessment lab 240 determines a market value of the silver sent by system 300, and sends back a message to system 300 to inform system 300 of the assessed market value. In response, system 300 uses the tracking identifier 52, and the data structure shown in FIG. 11, to access charity account record 330. System 300 stores the assessed dollar amount into charity record 330. (process 327).

Periodically, such as monthly, hardware in system 300 executes process 329, thereby sending accumulated funds to bank account 132, belonging to charity 130.

### Third Exemplary Embodiment

In accordance with a third embodiment, the donor requests the mailer via a web site. The web site may be for a single charity, or may allow the donor to select a charity.

### Other Options

Although a visible tracking identifier has been depicted on envelopes 50, a system could instead issue a mailing kit, or mailer, with the tracking information in a non-visible form, such as RFID; and/or with the tracking information on another element, such as a card that fits inside a mailing envelope.

A process, such as process 306, may allow a charity to create multiple accounts, each account corresponding to a respective program, drive, location, accounting period, etc. Each account would thus be associated its own set of mailer tracking numbers, payment information, program name, etc.

In another alternative implementation, although system 300 is not a charity, system 300 does not take proceeds for itself; system 300 takes no proceeds for overheads, salaries, or fundraising. System 300 does not charge an administrative fee to the donor or to the charity, though a handling fee of one dollar may deducted from donations of five dollars and under. The income for system 300 comes from fees to the processors and recyclers of the precious metals and jewels.

Thus the exemplary systems and methods enable charities to promote envelopes/program through a variety of announcements, mailings, flyers, newsletters, newspapers, press releases, local news outlets, handbills, e mail campaigns, radio, or TV advertisements. The exemplary systems and methods also enable charities to additionally or alternately distribute envelopes directly in key locations, and events or gives to volunteers for handouts.

Emergency supplies of Envelope packs will be maintained for immediate Charity handout or distribution.

In this patent application, the word circuitry encompasses dedicated hardware, and/or programmable hardware, such as a central processing unit (CPU) or reconfigurable logic array, in combination with programming data, such as sequentially fetched CPU instructions or programming data for a reconfigurable array. Thus, circuitry encompasses, for example, a general-purpose electronic processor programmed with software, acting to carry out a described function.

In this patent application, software and data may be arranged in a particular fashion, and certain processing may be depicted in serial, parallel, or other fashion, for ease of description. Actual hardware and software realizations, however, may be varied depending on desired optimizations apparent to one of ordinary skill in the art.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A method for a system having a plurality of first entities, and a second entity, each first entity having a respective bank account, each first entity being non-affiliated with each of the other first entities, the second entity being non-affiliated with each of the first entities, the method comprising the steps, performed under control of the second entity, of:
receiving a mass of metal from a person, the person being a member of the general public, the mass of metal not being U.S. currency; and
crediting the bank account of a selected one of the plurality of first entities with an amount, the amount corresponding to a market value of the mass of metal.

2. The method of claim 1 wherein the system further includes a mailing kit, and the method further includes the step, performed while the mailing kit under control of the second business entity, of:
generating an association between an identifier and the selected one of the first entities,
and the method further includes
sending the mailing kit such that the mailing kit is not under control of the second business entity, the mailing kit bearing the identifier at the time of sending,
wherein the receiving step includes
receiving the mass of metal in the mailing kit.

3. The method of claim 2 wherein the identifier includes a tracking number.

4. The method of claim 2 wherein sending the mailing kit includes sending the mailing kit to the selected first entity.

5. The method of claim 2 wherein sending the mailing kit includes sending the mailing kit to the person, without sending the mailing kit to the selected first entity.

6. The method of claim 5 wherein sending the mailing kit is performed in response to receiving a request from the person via telephone.

7. The method of claim 5 wherein sending the mailing kit is performed in response to receiving a request from the person via the Internet.

8. The method of claim 5 wherein sending the mailing kit is performed in response to receiving a request from the person via a Web site operated under control of the selected first entity.

9. The method of claim 5 wherein sending the mailing kit is performed in response to receiving a request from the person via a Web site operated under control of the second entity.

10. The method of claim 1 wherein the receiving step is performed a plurality of times for a plurality of different persons, the crediting step is performed a plurality of times for a plurality of different first entities, and the method further includes the step, performed under control of the second entity, of:
liquefying the received masses of metal.

11. The method of claim 1 wherein liquefying includes liquefying in a common facility.

12. The method of claim 1 wherein liquefying includes liquefying in a common furnace.

13. The method of claim 1 wherein each first entity is a non-profit organization

14. The method of claim 1 wherein each first entity is exempt from U.S. income tax.

15. The method of claim 1 wherein each first entity is a non-profit organization according to 26 United States Code 501(c)(3).

16. The method of claim 1 wherein the person is entitled to a deduction in his income tax calculation, as a result of sending the metal.

17. The method of claim 1 wherein a step of selecting the first entity is performed before the step receiving a mass of metal.

18. The method of claim 1 further including a step of directing a message toward the general public, the message identifying first entity in the plurality of first entities, the message including a locator corresponding to the entity.

19. The method of claim 18 wherein directing includes sending the message in a television signal

20. The method of claim 18 wherein directing includes placing the message adjacent a news item.
